(19) United States
(12) Patent Application Publication
(10) Pub. No.: US 2023/0323094 A1
(43) Pub. Date: Oct. 12, 2023

(54) Cellulose Ester Composition With Enhanced Properties and Articles Made Therefrom

(71) Applicant: Celanese International Corporation, Irving, TX (US)

(72) Inventors: Rongfu Li, Narrows, VA (US); Michael Combs, Shady Spring, WV (US); Xiaowei Zhang, Union, KY (US); Chongwen Huang, Florence, KY (US); Christopher McGrady, Walton, KY (US)

(21) Appl. No.: 18/297,340

(22) Filed: Apr. 7, 2023

Related U.S. Application Data
(60) Provisional application No. 63/328,859, filed on Apr. 8, 2022.

(51) Int. Cl. C08L 1/12

(52) U.S. Cl. CPC C08L 1/12; C08L 2205/03

(57) ABSTRACT

A polymer composition containing a cellulose ester polymer in combination with one or more plasticizers. One of the plasticizers can be polyethylene glycol. The polyethylene glycol plasticizer can have a number average molecular weight that has been found to improve one or more properties of the composition or of articles made from the composition.

### RELATED APPLICATIONS

The present application is based upon and claims priority to U.S. Provisional Patent Application Ser. No. 63/328,859, having a filing date of Apr. 8, 2022, and which is incorporated herein by reference.

### BACKGROUND

Each year, the global production of plastics continues to increase. Over one-half of the amount of plastics produced each year are used to produce plastic bottles, containers, drinking straws, and other single-use items. For example, over 100 million disposable plastic straws are manufactured and placed in use every year.

The discarded, single-use plastic articles, including plastic drinking bottles and straws, are typically not recycled and end up in landfills. In addition, many of these items are not properly disposed of and end up in streams, lakes, and in the oceans around the world. In fact, plastic waste tends to agglomerate and concentrate in oceans in certain areas of the world due to currents and the buoyancy of the products.

Plastic waste can be harmful to ecosystems and to animals, including marine life and birds. Plastic waste, for instance, disintegrates very slowly into smaller and smaller pieces that become ingested by aquatic organisms and fish.

In view of the above, those skilled in the art have attempted to produce plastic articles made from biodegradable polymers. Many biodegradable polymers, however, lack the physical properties and characteristics of conventional polymers, such as polypropylene and/or polyethylene terephthalate.

Cellulose esters have been proposed in the past as a replacement to some petroleum-based polymers or plastics. Cellulose esters, for instance, are generally considered environmentally-friendly polymers because they are recyclable, degradable and derived from renewable resources, such as wood pulp. Problems have been experienced, however, in melt processing cellulose ester polymers, such as cellulose acetate polymers. The polymer materials are relatively stiff and have relatively poor elongation properties. In addition, the melting temperature of cellulose ester polymers is very close to the degradation temperature, further creating obstacles to melt processing the polymers successfully.

Consequently, cellulose ester polymers are typically combined with a plasticizer in order to improve the melt processing properties of the material. Adding plasticizers to cellulose ester polymers, however, can produce various drawbacks and deficiencies. For example, the plasticizer selected can be less biodegradable than the cellulose ester polymer. In addition, the plasticizer can have an adverse impact on the physical properties of the resulting polymer composition by reducing crystallinity. A reduction in crystallinity can cause a reduction in modulus, stiffness, and/or strength. Additionally, the plasticizers commonly used in combination with cellulose ester polymers can reduce transparency. Plasticizers can also leach out of molded articles made from the polymer composition.

In view of the above, a need currently exists for improved biodegradable polymer compositions that have similar properties to petroleum-based polymers and can be melt processed for forming various three-dimensional articles. A need also exists for a cellulose ester polymer composition that is substantially biodegradable and that exhibits enhanced transparency, enhanced impact strength, and/or enhanced tensile strength.

### SUMMARY

In general, the present disclosure is directed to a polymer composition containing a cellulose ester polymer, such as cellulose acetate, in combination with at least one plasticizer. The at least one plasticizer can comprise one or more polyethylene glycols having a selected number average molecular weight. Each component contained in the polymer composition is designed to improve at least one property and/or improve the melt processing characteristics of the cellulose ester polymer. The plasticizer, for instance, can not only improve the melt processing characteristics of the cellulose ester polymer but can also greatly enhance various physical properties such as by decreasing stiffness, increasing elongation, increasing toughness, enhancing transparency, and/or increasing crystallinity. The polymer composition is well suited for producing polymer articles, such as beverage holders, other plastic containers, packaging, drinking straws, hot beverage pods, automotive parts, consumer appliance parts, and the like.

In one aspect, the present disclosure is directed to a polymer composition containing a cellulose ester polymer in combination with at least one plasticizer. The at least one plasticizer can comprise polyethylene glycol having a number average molecular weight from about 100 g/mol to about 800 g/mol. The polyethylene glycol can be present in the polymer composition in an amount from about 2% to about 50% by weight of the polymer composition.

The polymer composition of the present disclosure can exhibit a degree of crystallinity from about 2% to about 40%.

In one embodiment, the polymer composition of the present disclosure can be formulated to exhibit a haze from about 1% to about 20%.

The polymer composition can comprise a second plasticizer in addition to first polyethylene glycol plasticizer. For instance, the second plasticizer can be a polyethylene glycol having a different molecular weight. For example, the polyethylene glycol can have a number average molecular weight from about 1000 g/mol to about 15000 g/mol. The second plasticizer can be present in the polymer composition in an amount from about 3% to about 30% by weight.

In one aspect, the polymer composition can comprise glycerol triacetate, triethyl citrate, acetyl triethyl citrate, or mixtures thereof.

The cellulose ester polymer can be present in the composition in an amount from about 50% to about 95% by weight, such as from about 70% to about 75% by weight. The at least one plasticizer can be present in the composition in an amount from about 5% to about 50% by weight, such as from about 25% to about 30% by weight. The cellulose ester polymer can be comprised primarily of cellulose diacetate.

The polymer composition can exhibit at least one crystallization peak temperature from about 150° C. to about 220° C. as determined by differential scanning calorimetry. Further, the polymer composition can exhibit an enthalpy of crystallization from about 1 J/g to about 7 J/g as determined by differential scanning calorimetry. Additionally, the polymer composition can exhibit an enthalpy of fusion from about 2 J/g to about 8 J/g as determined by differential scanning calorimetry.

In one aspect, the polymer composition further comprises an antioxidant. For instance, in one aspect, the antioxidant is a phosphite.

In one aspect, the polymer composition further comprises a polycarboxylic acid. For instance, in one aspect, the polycarboxylic acid is citric acid.

The present disclosure is also directed to an article made from the polymer composition as described above. Polymer articles that may be made in accordance with the present disclosure include packaging, drinking straws, beverage holders, automotive parts, such as interior automotive parts, hot beverage pods, knobs, door handles, lids, cutlery, consumer appliance parts, containers and any other suitable disposable product. For instance, the present disclosure is also directed to a drinking straw comprising an elongated tubular member defining a passageway from a first end to a second and opposite end. The drinking straw is formed from a polymer composition as described above.

The cellulose ester polymer composition can also be used to produce molded articles for use in the medical field.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present disclosure.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer compositions containing a cellulose ester polymer in combination with other polymers and components that improve the melt processing properties of the cellulose ester polymer and/or the physical properties of the cellulose ester polymer. In accordance with the present disclosure, a cellulose ester polymer is combined with at least one plasticizer. The at least one plasticizer, for instance, can enhance transparency as to render the polymer composition generally clear or translucent. Further, the at least one plasticizer can enhance the impact strength of the cellulose ester polymer and can enhance the tensile strength of the cellulose ester polymer.

Polymer compositions formulated in accordance with the present disclosure can also have dramatically improved stiffness and elongation properties in addition to low acetic acid emission characteristics. Further, the polymer composition of the present disclosure can be formulated to be biodegradable and thus environmentally friendly. The polymer composition can be used to form all different types of products using any suitable molding technique, such as extrusion, injection molding, rotational molding, thermoforming, and the like.

In general, any suitable polysaccharide ester polymer can be incorporated into the polymer composition of the present disclosure. In one aspect, the polysaccharide ester polymer is a cellulose ester polymer such as a cellulose acetate.

Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one aspect, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000, such as greater than about 20,000, such as greater than about 30,000, such as greater than about 40,000, such as greater than about 50,000. The molecular weight of the cellulose acetate is generally less than about 300,000, such as less than about 250,000, such as less than about 200,000, such as less than about 150,000, such as less than about 100,000, such as less than about 90,000, such as less than about 70,000, such as less than about 50,000. The molecular weights identified above refer to the number average molecular weight. Molecular weight can be determined using gel permeation chromatography using a polystyrene equivalent or standard.

The cellulose ester polymer or cellulose acetate can have an intrinsic viscosity of generally greater than about 0.5 dL/g, such as greater than about 0.8 dL/g, such as greater than about 1 dL/g, such as greater than about 1.2 dL/g, such as greater than about 1.4 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$\begin{matrix}IV = ( \frac{k}{c} ) ( antilog ( ( log {n}_{ret} ) / k ) - 1 ) \\ where {n}_{ret} = ( \frac{{t}_{1}}{{t}_{2}} ) ,\end{matrix} \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose ester polymer can generally have a degree of substitution of greater than about 2, such as greater than about 2.2, such as greater than about 2.3, such as greater than about 2.4, such as greater than about 2.5. The degree of substitution is generally less than about 3, such as less than about 2.9, such as less than about 2.8, such as less than about 2.7, such as less than about 2.65.

In general, the cellulose ester polymer, such as cellulose acetate, can be present in the polymer composition in an amount from about 15% by weight to about 95% by weight, including all increments of 1% by weight therebetween. The cellulose ester polymer is generally present in the polymer composition in an amount greater than about 15% by weight, such as in an amount greater than about 25% by weight, such as in an amount greater than about 35% by weight, such as in an amount greater than about 45% by weight, such as in an amount greater than about 55% by weight, such as in an amount greater than about 65% by weight, such as in an amount greater than about 75% by weight. The cellulose ester polymer is generally present in the polymer composition in an amount less than about 85% by weight, such as in an amount less than about 80% by weight, such as in an amount less than about 75% by weight, such as in an amount less than about 70% by weight, such as in an amount less than about 65% by weight, such as in an amount less than about 55% by weight, such as in an amount less than about 45% by weight. In one aspect, the cellulose ester polymer can be present in the polymer composition in an amount from about 50% to about 95% by weight, such as from about 70% to about 75% by weight.

A cellulose ester polymer as described above can be combined with one or more plasticizers. In accordance with the present disclosure, the at least one plasticizer can comprise polyethylene glycol, a first plasticizer, having a number average molecular weight from about 100 g/mol to about 800 g/mol. The number average molecular weight of the polyethylene glycol can be greater than about 100 g/mol, such as greater than about 200 g/mol, such as greater than about 300 g/mol, such as greater than about 400 g/mol, such as greater than about 500 g/mol and less than about 750 g/mol, such as less than about 650 g/mol, such as less than about 550 g/mol, such as less than about 450 g/mol, such as less than about 400 g/mol. In one aspect, the polyethylene glycol plasticizer can have a viscosity from about 4.0 cSt to about 15.0 cSt. Further, in one aspect, the polyethylene glycol plasticizer can have a pH from about 4.5 to about 7.5. Additionally, the polyethylene glycol plasticizer can have a hydroxyl value from about 130 mgKOH/gm to about 620 mgKOH/gm. The polyethylene glycol can be a liquid at room temperature [22° C.±2]. Further, the polyethylene glycol can be generally soluble in water, acetone, alcohols, and chlorinated solvents. Generally, polyethylene glycol exhibits enhanced biodegradability as compared to traditional plasticizers. Indeed, polyethylene glycol has demonstrated favorable aerobic and anaerobic biodegradability. Notably, the biodegradability of polyethylene glycol has resulted in its significant use in the medical field, such as use as an excipient.

In general, the first plasticizer, or polyethylene glycol, can be present in the polymer composition in an amount from about 2% to about 50% by weight, including all increments of 0.1% by weight therebetween. The polyethylene glycol plasticizer, for example, can be present in the polymer composition in an amount greater than about 5% by weight, such as in an amount greater than about 10% by weight, such as in an amount greater than about 15% by weight, such as in an amount greater than about 20% by weight, such as in an amount greater than about 25% by weight, such as in an amount greater than about 30% by weight. The polyethylene glycol plasticizer can generally be present in the polymer composition in an amount less than about 35% by weight, such as in an amount less than about 30% by weight, such as in an amount less than about 28% by weight, such as in an amount less than about 25% by weight, such as in an amount less than about 20% by weight, such as in an amount less than about 18% by weight, such as in an amount less than about 15% by weight, such as in an amount less than about 10% by weight.

In one aspect, one or more additional plasticizers can be present in the polymer composition. For instance, the composition can contain a second plasticizer, a third plasticizer, or a fourth plasticizer. Additional plasticizers well suited for use in the polymer composition of the present disclosure and combined with the first plasticizer include polyethylene glycol, triacetin, monoacetin, diacetin, and mixtures thereof. Other suitable plasticizers include tris(clorisopropyl) phosphate, tris(2-chloro-1-methylethyl) phosphate, glycerol triacetate, triethyl citrate, acetyl triethyl citrate, glycerin, or mixtures thereof.

As previously disclosed, in one aspect, the polymer composition can contain a second plasticizer. For instance, the second plasticizer can be polyethylene glycol that has a number average molecular weight greater than the first plasticizer. The number average molecular weight of the second plasticizer can be from about 1000 g/mol to about 15000 g/mol including all increments of 1 g/mol therebetween. In one aspect, the number average molecular weight of the second polyethylene glycol plasticizer can be greater than about 1500 g/mol, such as greater than about 2000 g/mol, such as greater than about 2500 g/mol, such as greater than about 3000 g/mol, such as greater than about 3500 g/mol, such as greater than about 4000 g/mol, such as greater than about 4500 g/mol, such as greater than about 5000 g/mol, and generally less than about 15000 g/mol, such as less than about 13000 g/mol, such as less than about 10,000 g/mol, such as less than about 8000 g/mol, such as less than about 6,000 g/mol, such as less than about 4000 g/mol. In certain embodiments, the second polyethylene glycol plasticizer can have a number average molecular weight of from about 1000 g/mol to about 2500 g/mol, or from about 2500 g/mol to about 5000 g/mol, or from about 5000 g/mol to about 15000 g/mol.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. For example, using a bio-based plasticizer can render the polymer composition well suited for contact with food items. Bio-based plasticizers particular rly well suited for use in the composition of the present disclosure include an alkyl ketal ester, a non-petroleum hydrocarbon ester, a bio-based polymer or oligomer, such as polycaprolactone, having a number average molecular weight of 1000 or less, or mixtures thereof.

In one aspect, the bio-based plasticizer is an alkyl ketal ester having a chemical structure corresponding to Structure I as provided below:

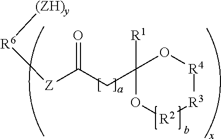

wherein a is from 0 to 12; b is 0 or 1; each R¹ is independently hydrogen, a hydrocarbyl group, or a substituted hydrocarbyl group; each R², R³, and R⁴ are independently methylene, alkylmethylene, or dialkylmethylene, x is at least 1, y is 0 or a positive number and x+y is at least 2; R⁶ is a hydrocarbyl group or a substituted hydrocarbyl group and each Z is independently —O—, —NH— or —NR— where R is a hydrocarbyl group or a substituted hydrocarbyl group.

The plasticizer identified above corresponds to a reaction product of a polyol, aminoalcohol or polyamine and certain 1,2- and/or 1,3-alkanediol ketal of an oxocarboxylate esters. 1,2- and 1,3-alkanediols ketals of oxocarboxylate esters are referred to herein as “alkyl ketal esters”. Up to one mole of alkyl ketal ester can be reacted per equivalent of hydroxyl groups or amino groups provided by the polyol, aminoalcohol or polyamine. The polyol, aminoalcohol or polyamine is most preferably difunctional, but polyols, aminoalcohols and polyamines having more than two hydroxyl and/or amino groups can be used.

The values of x and y in structure I will depend on the number of hydroxyl groups or amino groups on the polyol, aminoalcohol or polyamine, the number of moles of the alkyl ketal ester per mole of the polyol, aminoalcohol or polyamine, and the extent to which the reaction is taken towards completion. Higher amounts of the alkyl ketal ester favor lower values for y and higher values of x.

In structure I, y is specifically from 0 to 2 and x is specifically at least 2. All a in structure I are specifically 2 to 12, more specifically, 2 to 10, more specifically, 2 to 8, more specifically, 2 to 6, more specifically, 2 to 4, and more specifically, 2. All R¹ are specifically an alkyl group, specifically methyl. In some embodiments of structure I, all Z are —O—, y is 0 and x is 2; these products correspond to a reaction of two moles of an alkyl ketal ester and one mole of a diol. In some other embodiments, all Z are —O—, y is 1 and x is 1; these products correspond to the reaction of one mole of the alkyl ketal ester and one mole of a diol.

In one aspect, all b are 0. In another aspect, all b are 1.

Some specific compounds according to structure I include those having the structure:

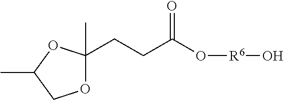

or the structure

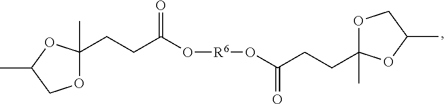

or the structure

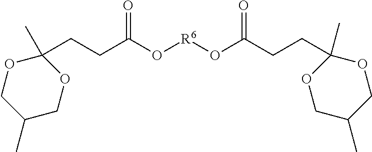

particularly in which R⁶ is —(CH₂)—ₘ wherein m is from 2 to 18, especially 2, 3, 4 or 6. In one specific aspect, R⁶ corresponds to the residue, after removal of hydroxyl groups, of 1,4-butane diol resulting in the structure (Ia)

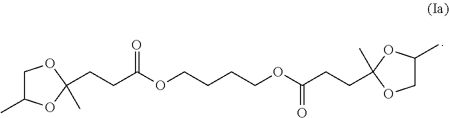

In another specific aspect, R⁶ corresponds to the residue, after removal of hydroxyl groups, of diethylene glycol resulting in structure (Ib)

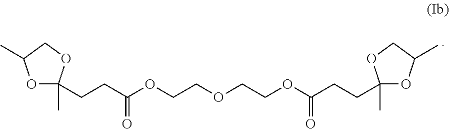

In another specific aspect, R⁶ corresponds to the residue, after removal of hydroxyl groups, of 2-methyl. 1-3 propane diol resulting in structure (Ic)

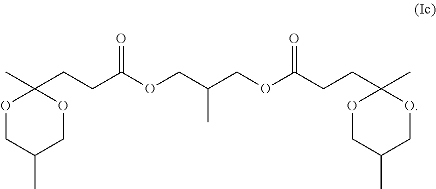 [SMILES: CC(COC(=O)CCC1(C)OCC(C)CO1)COC(=O)CCC1(C)OCC(C)CO1]

Compounds according to structure I can be prepared in a transesterification or ester-aminolysis reaction between the corresponding polyol, aminoalcohol or polyamine and the corresponding alkyl ketal ester. Alternatively, compounds according to structure I can be prepared by reacting an oxocarboxylic acid with the polyol, aminoalcohol or polyamine to form an ester or amide, and then ketalizing the resulting product with a 1,2- or 1,3-alkane diol such as ethylene glycol, 1,2-propanediol, 1,3-propanediol, 2-methyl, 1-3 propane diol, 1,2-butanediol, 1,3-butanediol, 1,2-pentanediol, 1,3-pentanediol, 1,2-hexanediol, 1,3-hexanediol, and the like.

Alkyl ketal ester plasticizers are particularly well suited for use in conjunction with one or more other plasticizers. For example, in one aspect, an alkyl ketal ester plasticizer can be combined with a benzoate ester. The weight ratio between the two plasticizers can vary such as from about 1:10 to about 10:1, such as from about 1:4 to about 4:1.

Another bio-based plasticizer that may be incorporated into the polymer composition of the present disclosure is a non-petroleum hydrocarbon ester. For example, one example of a non-petroleum hydrocarbon ester is sold under the tradename HALLGREEN by the Hall Star Company of Chicago, Illinois. Non-petroleum hydrocarbon ester plasticizers, for instance, can contain greater than about 50% by weight, such as greater than about 70% by weight, such as greater than about 99% by weight of bio-based content. The esters, for instance, can be derived primarily from agricultural, forestry, or marine materials and thus are biodegradable. In one aspect, the non-petroleum hydrocarbon ester plasticizer has a specific gravity at 25° C. of about 1.16 or greater, such as about 1.165 or greater, such as about 1.17 or greater, such as about 1.74 or greater, and generally about 1.19 or less, such as about 1.185 or less, such as about 1.18 or less, such as about 1.78 or less. The non-petroleum hydrocarbon ester plasticizer can have an acid value of from about 0.5 mgKOH/g to about 0.6 mgKOH/g , such as from about 0.53 mgKOH/g to about 0.57 mgKOH/g.

In another aspect, the polymer composition can contain a bio-based plasticizer that is a bio-based polyester, such as a bio-based aliphatic polyester having a relatively low molecular weight. For example, the plasticizer can comprise a bio-based polyester polymer having a number average molecular weight of less than about 1000, such as less than about 900, such as less than about 800, and generally greater than about 500. In one aspect, the bio-based plasticizer is a polycaprolactone having a number average molecular weight of 1000 or less. Alternatively, the bio-based plasticizer may be a polyhydroxyalkanoate having a number average molecular weight of 1000 or less.

Each additional plasticizer (e.g. second plasticizer, third plasticizer, etc.) can be present in the polymer composition in an amount from about 2% to about 30% by weight. For example, each additional plasticizer can generally be present in the polymer composition in an amount greater than about 3% by weight, such as in an amount greater than about 4% by weight, such as in an amount greater than about 6% by weight, such as in an amount greater than about 8% by weight, such as in an amount greater than about 10% by weight, such as in an amount greater than about 12% by weight. Each additional plasticizer is generally present in the polymer composition in an amount less than about 30% by weight, such as in an amount less than about 25% by weight, such as in an amount less than about 20% by weight, such as in an amount less than about 15% by weight, such as in an amount less than about 10% by weight, such as in an amount less than about 8% by weight, such as in an amount less than about 5% by weight.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

The cellulose ester polymer can be present in relation to the at least one plasticizer or the total amount of plasticizers present such that the weight ratio between the cellulose ester polymer and the one or more plasticizers is from about 60:40 to about 85:15, such as from about 70:30 to about 80:20.

In another aspect, the cellulose ester polymer and one or more plasticizers can be combined with one or more acid scavengers to reduce acid emissions, such as acetic acid emissions. Compounds that can be used as acid scavengers include alkali metal salts, alkaline earth metal salts, or mixtures thereof. The acid scavenger, for example can be a carbonate, an oxide, a hydroxide, an amine, or mixtures thereof.

In one aspect, the acid scavenger is a zinc compound, such as a zinc oxide. Zinc compounds have been found to be particularly effective in polymer compositions formulated in accordance with the present disclosure. A particularly effective acid scavenger package includes a zinc compound in combination with another acid scavenger. The other acid scavenger can comprise other metal salts, such as a carbonate, an oxide, or a hydroxide. For example, in one aspect, a zinc compound can be combined with a carbonate, such as calcium carbonate. The weight ratio between the zinc compound and the other acid scavenger can be from about 10:1 to about 1:10, such as from about 5:1 to about 1:5.

In another aspect, the acid scavenger can comprise an aluminum sodium carbonate compound, an aluminum silicate, a magnesium compound, such as magnesium oxide or magnesium hydroxide, and mixtures thereof.

In still another aspect, the acid scavenger can comprise a hydrotalcite. The hydrotalcite may be used alone or in conjunction with another acid scavenger, such as a zinc compound. The hydrotalcite may have the following chemical formula:

Mg6Al2CO3(OH)16·4(H2O).

The acid scavenger, such as a hydrotalcite, may optionally be coated. Example coatings include fatty acids (e.g., higher fatty acids), anionic surfactants, phosphates, coupling agents, and esters of polyhydric alcohols and fatty acids. Specific examples in some embodiments include higher fatty acids having 10 or more carbon atoms such as stearic acid, erucic acid, palmitic acid, lauric acid and behenic acid; alkali metal salts of the higher fatty acids; sulfuric ester salts of higher alcohols such as stearyl alcohol and oleyl alcohol; anionic surfactants such as sulfuric ester salts of polyethylene glycol ethers, amide-bonded sulfuric ester salts, ester-bonded sulfuric ester salts, ester-bonded sulfonates, amide-bonded sulfonates, ether-bonded sulfonates, ether-bonded alkyl aryl sulfonates, ester-bonded alkyl aryl sulfonates and amide-bonded alkyl aryl sulfonates; phosphates such as acid and alkali metal salts and amine salts of orthophosphoric acid and mono- or di-esters such as oleyl alcohol and stearyl alcohol or mixtures thereof; silane coupling agents such as vinylethoxysilane, vinyl-tris(2-methoxy-ethoxy)silane, γ-methacryloxypropyl trimethoxysilane, γ-aminopropyl trimethoxysilane, β-(3,4-epoxycyclohexyl)ethyl trimethoxysilane, γ-glycidoxypropyl trimethoxysilane and γ-mercaptopropyl trimethoxysilane; titanate-based coupling agents such as isopropyltriisostearoyl titanate, isopropyltris(dioctylpyrophosphate)titanate, isopropyltri(N-aminoethyl-aminoethyl)titanate and isopropyltridecylbenzenesulfonyl titanate; aluminum-based coupling agents such as acetoalkoxyaluminium diisopropylate; and esters of polyhydric alcohols and fatty acids such as glycerin monostearate and glycerin monooleate.

As described above, the acid scavenger can be very effective at preventing acid emissions within the polymer composition even at extremely and surprisingly low concentrations. For instance, the acid scavenger concentration within the polymer composition can be about 2.5% by weight or less, such as about 2% by weight or less, such as about 1.5% by weight or less, such as about 1% by weight or less, such as about 0.5% by weight or less. For example, one or more acid scavengers can be present in the polymer composition at a concentration that is less than about 250 ppm, such as less than about 200 ppm, such as less than about 150 ppm, such as less than about 100 ppm, such as less than about 50 ppm. The acid scavenger concentration can be greater than about 20 ppm, such as greater than about 50 ppm.

In addition to an acid scavenger as described above, the polymer composition can also contain an odor masking agent. The odor masking agent, for instance, can absorb odors and/or produce its own odor. Masking agents that may be incorporated into the composition include zeolites, particularly synthetic zeolites, fragrances, and the like.

The cellulose ester polymer and the one or more plasticizers can also be combined with one or more bio-based polymers that are different than the cellulose ester polymer and the one or more plasticizers. As used herein, a “bio-based” polymer or plasticizer refers to a polymer, oligomer, or compound produced from at least partially renewable biomass sources, such as produced from plant matter or food waste. For example, a bio-based polymer can be a polymer produced from greater than 30% renewable resources, such as greater than about 40% renewable resources, such as greater than about 50% renewable resources, such as greater than about 60% renewable resources, such as greater than about 70% renewable resources, such as greater than about 80% renewable resources, such as greater than about 90% renewable resources. Bio-based polymers are to be distinguished from polymers derived from fossil resources such as petroleum. Bio-based polymers can be bio-derived meaning that the polymer originates from a biological source or produced via a biological reaction, such as through fermentation or other microorganism process. Although a cellulose ester polymer can be considered a bio-based polymer, the term herein refers to other bio-based substances that can be combined with cellulose ester polymers.

In one aspect, the bio-based polymer can be a polyester polymer, such as an aliphatic polyester. Particular bio-based polymers that may be incorporated into the polymer composition include polyhydroxyalkanoates, polylactic acid, polycaprolactone, or mixtures thereof.

In one aspect, the physical properties of the cellulose ester polymer, such as cellulose acetate, can be particularly improved if at least one bio-based polymer is combined with the cellulose ester polymer that has a low glass transition temperature and/or is amorphous or is semi-crystalline. For example, a bio-based polymer can be selected for combining with the cellulose ester polymer that is completely or substantially amorphous or has a low degree of crystallinity. The degree of crystallinity is the fraction of the polymer that exists in an orderly state, having a lattice structure. For example, the bio-based polymer combined with the cellulose ester polymer, such as cellulose acetate, can have a crystallinity of less than about 30%, such as less than about 25%, such as less than about 20%, such as less than about 15%, such as less than about 10%, such as less than about 5%. The degree of crystallinity can be determined using X-ray and electron diffraction, differential scanning calorimetry, infrared absorption (FTIR) or Raman spectroscopy.

The at least one bio-based polymer combined with the cellulose ester polymer can also have a relatively low glass transition temperature. For instance, the glass transition temperature of the bio-based polymer can be less than about 40° C., such as less than about 20° C., such as less than about 10° C., such as less than about 5° C., such as less than about 0° C., such as less than about −5° C., such as less than about −10° C., such as less than about −20° C. The glass transition temperature (Tg) is generally greater than about −40° C., such as greater than about −30° C.

In comparison, the glass transition temperature of cellulose ester polymer is generally from 160° C. to 180° C. Differences in glass transition temperatures can lead to compatibility issues. However, to the contrary, the use of a bio-based polymer with a low glass transition temperature and/or low crystallinity has been found to not only be compatible with cellulose acetate, but also improves many physical properties of the cellulose acetate including elongation to break and toughness. The addition of the bio-based polymer as described above can also reduce the flexural modulus.

In one aspect, the at least one bio-based polymer combined with the cellulose ester polymer, such as cellulose acetate, is a polyhydroxyalkanoate. The polyhydroxyalkanoate can be a homopolymer or a copolymer. Polyhydroxyalkanoates, also known as “PHAs”, are linear polyesters produced in nature by bacterial fermentation of sugar or lipids. More than 100 different monomers can be combined within this family to give materials with extremely different properties. Generally, they can be either thermoplastic or elastomeric materials, with melting-points ranging from 40 to 180° C. The most common type of PHAs is PHB (poly-beta-hydroxybutyrate). Poly(3-hydroxybutyrate) (PHB) is a type of a naturally occurring thermoplastic polymer currently produced microbially inside of the cell wall of a number of wild bacteria species or genetically modified bacteria or yeasts, etc. It is biodegradable and does not present environmental issues post disposal, i.e., articles made from PHB can be composted.

The one or monomers used to produce a PHA can significantly impact the physical properties of the polymer. For example, PHAs can be produced that are crystalline, semi-crystalline, or completely amorphous. For example, poly-4-hydroxybutyrate homopolymer can be completely amorphous with a glass transition temperature of less than about −30° C. and with no noticeable melting point temperature. Polyhydroxybutyrate-valerate copolymers also can be formulated to be semi-crystalline to amorphous having low stiffness characteristics.

Examples of monomer units that can be incorporated in PHAs include 2-hydroxybutyrate, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HH), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods described herein is a homopolymer (where all monomer units are the same). Examples of PHA homopolymers include poly 3-hydroxyalkanoates (e.g., poly 3-hydroxypropionate (hereinafter referred to as P3HP)), poly 3-hydroxybutyrate (hereinafter referred to as P3HB) and poly 3-hydroxyvalerate, poly 4-hydroxyalkanoates (e.g., poly 4-hydroxybutyrate (hereinafter referred to as P4HB)), poly 4- hydroxyvalerate (hereinafter referred to as P4HV)) or poly 5-hydroxyalkanoates (e.g., poly 5-hydroxyvalerate (hereinafter referred to as P5HV)).

In certain embodiments, the PHA can be a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as P3HB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

An example of a PHA having 4 different monomer units would be PHB-co-3HH-co-3HO-co-3HD or PHB-co-3-HO-co-3HD-co-3HDd. Typically where the PHB3HX has 3 or more monomer units, the 3HB monomer is at least 70% by weight of the total monomers, such as greater than 90% by weight of the total monomers.

In one aspect, a cellulose ester polymer is combined with a PHA that has a crystallinity of about 25% or less and has a low glass transition temperature. For instance, the glass transition temperature can be less than about 10° C., such as less than about 5° C., such as less than about 0° C., such as less than about −5° C., and generally greater than about −40° C., such as greater than about −20° C. Such PHAs can dramatically reduce the stiffness properties of the cellulose ester polymer, thereby increasing the elongation properties and decreasing the flexural modulus properties. As used herein, the glass transition temperature can be determined by dynamic mechanical analysis in accordance with ASTM Test E1640-09.

When present, one or more PHAs can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. One or more PHAs are generally present in the polymer composition in an amount of about 30% or less, such as in an amount of about 25% or less, such as in an amount of about 20% or less, such as in an amount of about 15% or less.

In addition to one or more PHAs, the polymer composition can contain various other bio-based polymers, such as a polylactic acid or a polycaprolactone. Polylactic acid also known as “PLAs” are well suited for combining with one or more PHAs. Polylactic acid polymers are generally stiffer and more rigid than PHAs and thus can be added to the polymer composition for further refining the properties of the overall formulation.

Polylactic acid may generally be derived from monomer units of any isomer of lactic acid, such as levorotory-lactic acid (“L-lactic acid”), dextrorotatory-lactic acid (“D-lactic acid”), meso-lactic acid, or mixtures thereof. Monomer units may also be formed from anhydrides of any isomer of lactic acid, including L-lactide, D-lactide, meso-lactide, or mixtures thereof. Cyclic dimers of such lactic acids and/or lactides may also be employed. Any known polymerization method, such as polycondensation or ring-opening polymerization, may be used to polymerize lactic acid. A small amount of a chain-extending agent (e.g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the content of one of the monomer units derived from L-lactic acid and the monomer units derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage.

In one particular aspect, the polylactic acid has the following general structure:

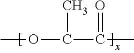

The polylactic acid typically has a number average molecular weight (“Mₙ”) ranging from about 40,000 to about 160,000 grams per mole, in some embodiments from about 50,000 to about 140,000 grams per mole, and in some embodiments, from about 80,000 to about 120,000 grams per mole. Likewise, the polymer also typically has a weight average molecular weight (“M_{w}”) ranging from about 80,000 to about 200,000 grams per mole, in some embodiments from about 100,000 to about 180,000 grams per mole, and in some embodiments, from about 110,000 to about 160,000 grams per mole. The ratio of the weight average molecular weight to the number average molecular weight (“M_{w}/Mₙ”), i.e., the “polydispersity index”, is also relatively low. For example, the polydispersity index typically ranges from about 1.0 to about 3.0, in some embodiments from about 1.1 to about 2.0, and in some embodiments, from about 1.2 to about 1.8. The weight and number average molecular weights may be determined by methods known to those skilled in the art.

The polylactic acid may also have an apparent viscosity of from about 50 to about 600 Pascal seconds (Pa·s), in some embodiments from about 100 to about 500 Pa·s, and in some embodiments, from about 200 to about 400 Pa·s, as determined at a temperature of 190° C. and a shear rate of 1000 sec⁻¹. The melt flow rate of the polylactic acid (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

Polylactic acid can be present in the polymer composition in an amount of about 1% or greater, such as in an amount of about 3% or greater, such as in an amount of about 5% or greater, and generally in an amount of about 20% or less, such as in an amount of about 15% or less, such as in an amount of about 10% or less, such as in an amount of about 8% or less.

As described above, another bio-based polymer that may be combined with cellulose ester polymer alone or in conjunction with other bio-based polymers is polycaprolactone having a molecular weight higher than a polycaprolactone plasticizer. Polycaprolactone, similar to PHAs, can be formulated to have a relatively low glass transition temperature. The glass transition temperature, for instance, can be less than about 10° C., such as less than about −5° C., such as less than about −20° C., and generally greater than about −60° C. The polymers can be produced so as to be amorphous or semi-crystalline. The crystallinity of the polymers can be less than about 50%, such as less than about 25%.

Polycaprolactones can be made having a number average molecular weight of generally greater than about 5000, such as greater than about 8000, and generally less than about 15000, such as less than about 12000.

Polycaprolactones can be contained in the polymer composition in an amount of about 2% or greater, such as about 3% or greater, such as about 5% or greater, such as about 7% or greater, such as about 10% or greater, such as about 12% or greater, such as about 15% or greater, such as about 18% or greater. Polycaprolactones are generally present in the polymer composition in an amount of about 30% or less, such as in an amount of about 25% or less, such as in an amount of about 20% or less, such as in an amount of about 15% or less.

Other bio-based polymers that may be incorporated into the polymer composition include polybutylene succinate, polybutylene adipate terephthalate, a plasticized starch, other starch-based polymers, and the like. In addition, the bio-based polymer can be a polyolefin or polyester polymer made from renewable resources. For example, such polymers include bio-based polyethylene, bio-based polybutylene terephthalate, and the like.

The polymer composition of the present disclosure may optionally contain various other additives and ingredients. For instance, the polymer composition may contain antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

In one aspect, the antioxidant incorporated into the polymer composition can be a phosphite. For example, the antioxidant can be a polyphosphite, such as a diphosphite. In one particular aspect, for instance, the antioxidant incorporated into the polymer composition is Bis(2,4-dicumylphenyl) pentaerythritol diphosphite.

Any of the above antioxidants, including the phosphites described above, can be incorporated into the polymer composition generally in an amount greater than about 0.001% by weight, such as in an amount greater than about 0.01% by weight, such as in an amount greater than about 0.05% by weight, such as in an amount greater than about 0.08% by weight, and generally in an amount less than about 0.35% by weight, such as in an amount less than about 0.3% by weight, such as in an amount less than about 0.25% by weight, such as in an amount less than about 0.2% by weight, such as in an amount less than about 0.15% by weight, such as in an amount less than about 0.1% by weight. In one aspect, the polymer composition contains a phosphite antioxidant alone or in combination with one of the other antioxidants described above.

The polymer composition of the present disclosure can be formed into any suitable polymer article using any technique known in the art. For instance, polymer articles can be formed from the polymer composition through extrusion, injection molding, blow molding, and the like.

Polymer compositions formulated in accordance with the present disclosure can display many improved properties and characteristics in relation to many cellulose ester polymer compositions formulated in the past.

For example, the polymer composition of the present disclosure can be formulated so as to exhibit a flexural modulus of about 2000 MPa or less, such as about 1900 MPa or less, such as about 1800 MPa or less, such as about 1700 MPa or less, such as about 1600 MPa or less. The flexural modulus can be about 500 MPa or greater, such as about 700 MPa or greater, such as about 1000 MPa or greater, such as about 1200 MPa or greater. The flexural modulus of the polymer composition may be measured by ISO Test 178:2010.

The polymer composition of the present disclosure can exhibit a tensile modulus about 2000 MPa or less, such as about 1900 MPa or less, such as about 1800 MPa or less, such as about 1700 MPa or less, such as about 1600 MPa or less. The tensile modulus can be about 800 MPa or greater, such as about 900 MPa or greater, such as about 1000 MPa or greater, such as about 1200 MPa or greater. The tensile modulus of the polymer composition can be measured by ISO Test 527-1:2012.

The polymer composition of the present disclosure can also display improved stretch characteristics. For instance, the polymer composition can exhibit an elongation at break of about 10% or greater, such as about 12% or greater, such as about 15% or greater, such as about 20% or greater, such as about 30% or greater, such as about 40% or greater, such as about 50% or greater, such as about 60% or greater, such as about 70% or greater, such as about 80% or greater. The elongation at break can be less than about 500%, such as less than about 400%, such as less than about 200%, such as less than about 150%. Elongation at break can be measured according to ISO Test 527-1:2012.

The polymer composition of the present disclosure can also display improved impact strength characteristics. For instance, the polymer composition can exhibit a notched Charpy impact strength from about 5 J/m² to about 60 J/m², such as greater than about 5 J/m², such as greater than about 10 J/m², such as greater than about 15 J/m², such as greater than about 20 J/m², such as greater than about 25 J/m², such as greater than about 30 J/m², such as greater than about 40 J/m², such as greater than about 50 J/m². Generally, the polymer composition exhibits a notched Charpy impact strength of less than about 60 J/m², such as less than about 50 J/m², such as less than about 40 J/m², such as less than about 30 J/m², such as less than about 25 J/m², such as less than about 20 J/m², such as less than about 15 J/m², such as less than about 10 J/m².

Additionally, the polymer composition of the present disclosure can also display improved tensile strength characteristics. For instance, the polymer composition can exhibit a tensile strength from about 10 MPa to about 120 MPa, such as greater than about 10 MPa, such as greater than about 20 MPa, such as greater than about 30 MPa, such as greater than about 40 MPa, such as greater than about 50 MPa, such as greater than about 60 MPa, such as greater than about 70 MPa, such as greater than about 80 MPa. Generally, the polymer composition exhibits a tensile strength less than about 120 MPa, such as less than about 80 MPa, such as less than about 70 MPa, such as less than about 60 MPa, such as less than about 50 MPa, such as less than about 40 MPa, such as less than about 30 MPa, such as less than about 20 MPa.

The polymer composition of the present disclosure can also display improved crystallinity characteristics. For instance, the polymer composition can exhibit a degree of crystallinity from about 2% to about 40%, such as greater than about 2%, such as greater than about 4%, such as greater than about 6%, such as greater than about 8%, such as greater than about 10%, such as greater than about 12%, such as greater than about 15%, such as greater than about 18%, such as greater than about 20%, such as greater than about 25%, such as greater than about 30%. The degree of crystallinity exhibited by the polymer composition is generally less than about 40%, such as less than about 30%, such as less than about 25%, such as less than about 20%, such as less than about 18%, such as less than about 15%, such as less than about 12%, such as less than about 10%, such as less than about 8%, such as less than about 6%, such as less than about 4%. The crystallinity of the polymer composition can be determined by using a value of 58.8 J/g for the enthalpy of fusion of 100% crystalline cellulose acetate. The degree of crystallinity is defined as follows:

Degree of Crystallinity (%)=((enthalpy of fusion−enthalpy of crystallization)/(enthalpy of fusion of 100% crystalline cellulose acetate))×100

The polymer composition of the present disclosure can also display improved haze characteristics. For instance, the polymer composition can exhibit a haze from about 0.1% to about 50%, such as greater than about 0.1%, such as greater than about 1° A), such as greater than about 2%, such as greater than about 5%, such as greater than about 8%, such as greater than about 10%, such as greater than about 15%, such as greater than about 20%, such as greater than about 25%, such as greater than about 35%. Generally, the polymer composition exhibits a haze of less than about 50%, such as less than about 35%, such as less than about 25%, such as less than about 20%, such as less than about 15%, such as less than about 10%, such as less than about 8%, such as less than about 5%, such as less than about 3%, such as less than about 2%, such as less than about 1%, such as less than about 0.8%, such as less than about 0.5%, such as less than about 0.4%, such as less than about 0.3%, such as less than about 0.2%. Polymer articles made according to the present disclosure can be measured for haze according to ASTM Test D1003 (2013). Haze can be measured using any acceptable instrument according to the ASTM Test including, for instance, a BYK Gardner Haze-Gard 4725 instrument. Haze can be measured on a test plaque, on a film made according to the present disclosure, or on the final thermoformed article. The test plaque can have any suitable thickness, such as 1 mm, 2 mm, 3 mm, or 4 mm.

The crystallization peak temperature of the polymer composition can be determined by differential scanning calorimetry (“DSC”) as is known in the art. The crystallization peak temperature is the differential scanning calorimetry peak crystallization temperature. The crystallization peak temperature is measured during the cooling stage of the differential scanning calorimetry process.

The polymer composition of the present disclosure can exhibit at least one crystallization peak temperature from about 150° C. to about 220° C. as determined by differential scanning calorimetry, such as from about 150° C. to about 155° C., such as from about 155° C. to about 160° C., such as from about 160° C. to about 165° C., such as from about 165° C. to about 170° C., such as from about 170° C. to about 175° C., such as from about 175° C. to about 18° C., such as from about 180° C. to about 185° C., such as from about 185° C. to about 190° C., such as from about 190° C. to about 195° C., such as from about 195° C. to about 200° C., such as from about 200° C. to about 205° C., such as from about 205° C. to about 210° C., such as from about 210° C. to about 215° C., such as from about 215° C. to about 220° C.

The polymer composition of the present disclosure can also exhibit at least one crystallization peak temperature from about −15° C. to about −30° C., such as from about −15° C. to about −20° C., from about −20° C. to about −25° C., such as from about −25° C. to about −30° C.

The melting peak temperature can be determined by differential scanning calorimetry (“DSC”) as is known in the art. The melting peak temperature is the differential scanning calorimetry (DSC) peak melting temperature. The melting peak temperature is measured during the second heating stage of the differential scanning calorimetry process.

The polymer composition of the present disclosure can exhibit at least one melting peak temperature from about 45° C. to about 245° C. as determined by differential scanning calorimetry, such as from about 45° C. to about 65° C., such as from about 65° C. to about 85° C., such as from about 85° C. to about 105° C., such as from about 105° C. to about 125° C., such as from about 125° C. to about 145° C., such as from about 145° C. to about 165° C., such as from about 165° C. to about 185° C., such as from about 185° C. to about 205° C., such as from about 205° C. to about 225° C., such as from about 225° C. to about 245° C.

The enthalpy of crystallization, also known as the heat of crystallization, of the polymer composition can additionally be determined by differential scanning calorimetry as known in the art. The polymer composition of the present disclosure can exhibit an enthalpy of crystallization from about 1 J/g to about 7 J/g, such as from about 1 J/g to about 2 J/g, such as from about 2 J/g to about 3 J/g, such as from about 3 J/g to about 4 J/g, such as from about 4 J/g to about 5 J/g, such as from about 5 J/g to about 6 J/g, such as from about 6 J/g to about 7 J/g.

The enthalpy of fusion, also known as the heat of fusion, of the polymer composition can additionally be determined by differential scanning calorimetry as known in the art. The polymer composition of the present disclosure can exhibit an enthalpy of fusion from about 2 J/g to about 8 J/g, such as from about 2 J/g to about 3 J/g, such as from about 3 J/g to about 4 J/g, such as from about 4 J/g to about 5 J/g, such as from about 5 J/g to about 6 J/g, such as from about 6 J/g to about 7 J/g, such as from about 7 J/g to about 8 J/g.

The polymer composition of the present disclosure can also include a polycarboxylic acid. A polycarboxylic acid is an acid containing two or more carboxylic groups. The polycarboxylic acid, for instance, can be a dicarboxylic acid or a tricarboxylic acid. In one aspect, the polycarboxylic acid can be citric acid. The polycarboxylic acid, such as the citric acid, can be present in the polymer composition in an amount greater than about 0.001% by weight, such as in an amount greater than about 0.005% by weight, such as in an amount greater than about 0.01% by weight, such as in an amount greater than about 0.03% by weight. One or more polycarboxylic acids can be present in the polymer composition generally in an amount less than about 0.1% by weight, such as in an amount less than about 0.08% by weight, such as in amount less than about 0.06% by weight, such as in an amount less than about 0.04% by weight.

Polymer articles that may be made in accordance with the present disclosure include drinking straws, beverage holders, automotive parts, knobs, door handles, consumer appliance parts, and the like.

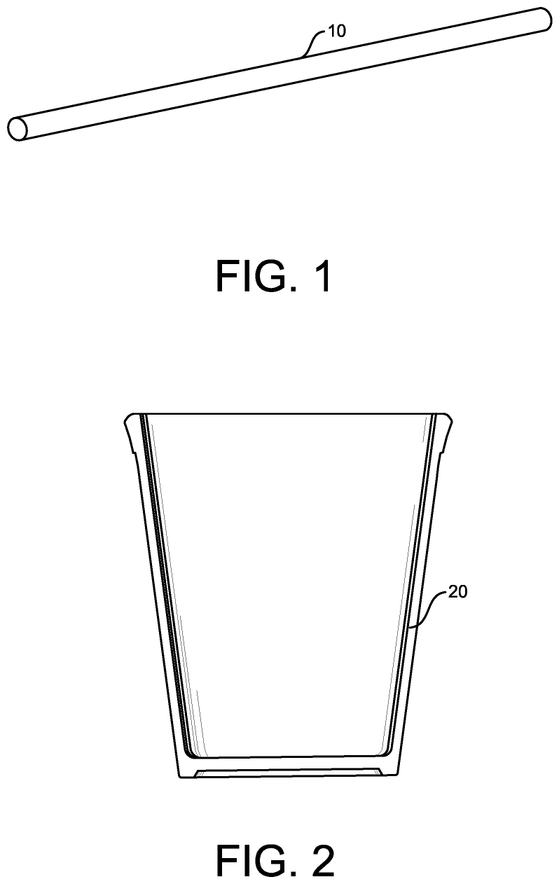

For instance, referring to FIG. 1, a drinking straw 10 is shown that can be made in accordance with the present disclosure. In the past, drinking straws were conventionally made from petroleum-based polymers, such as polypropylene. The cellulose ester polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

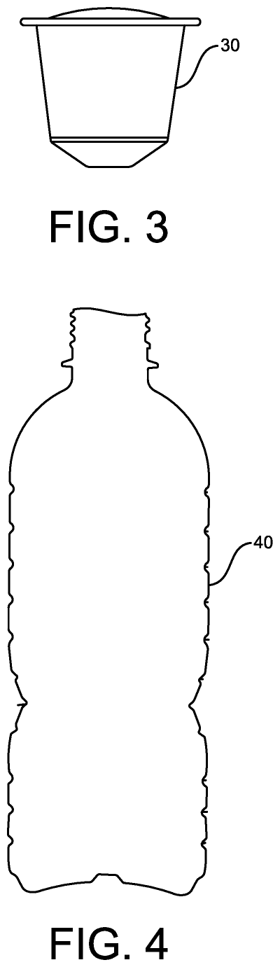

In still another aspect, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

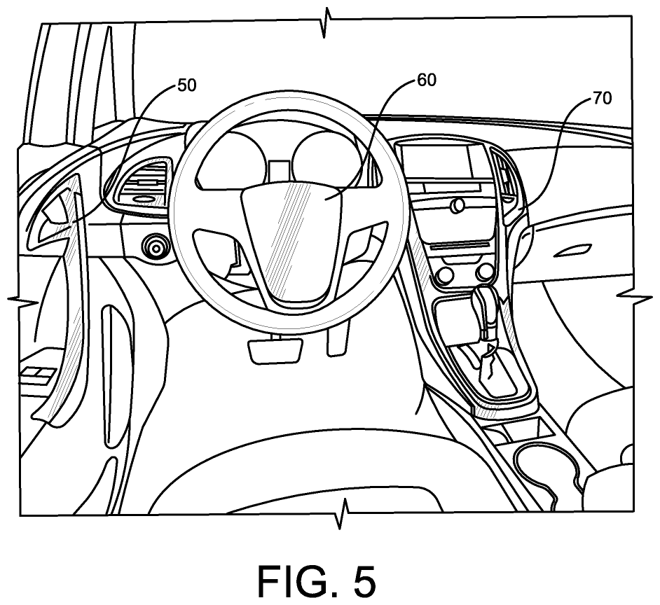

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

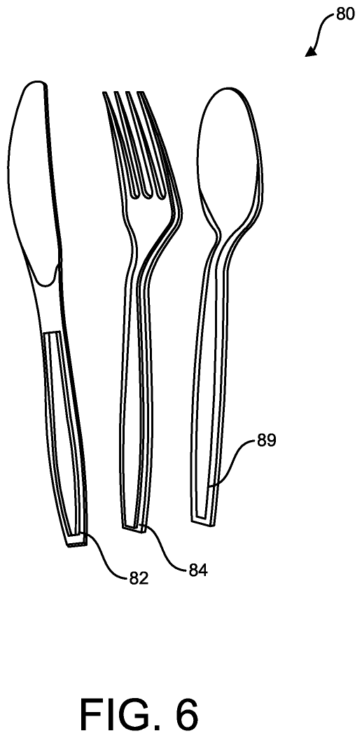

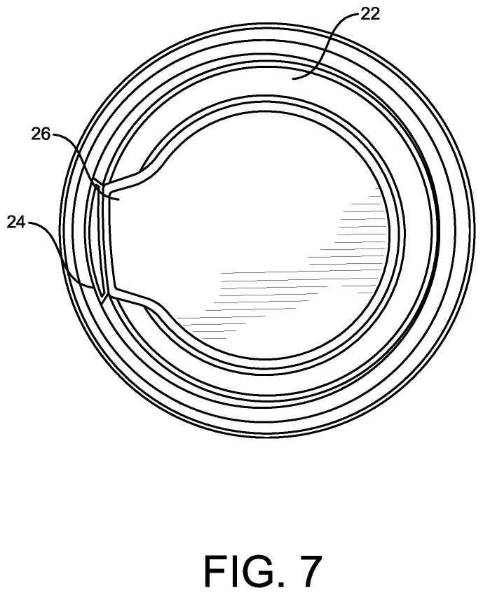

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

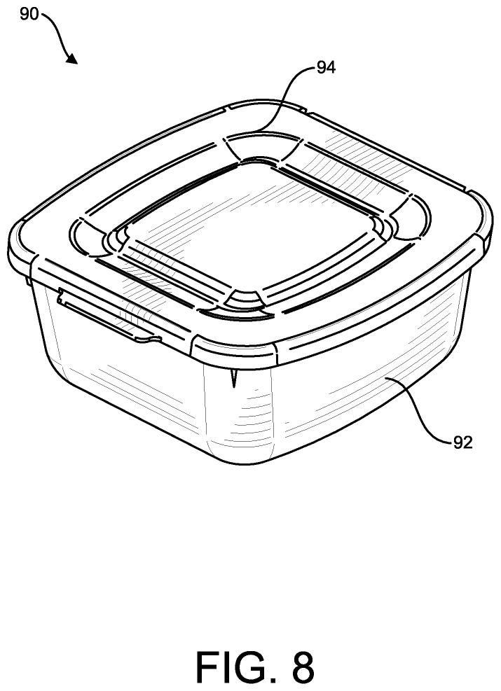

In still another aspect, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

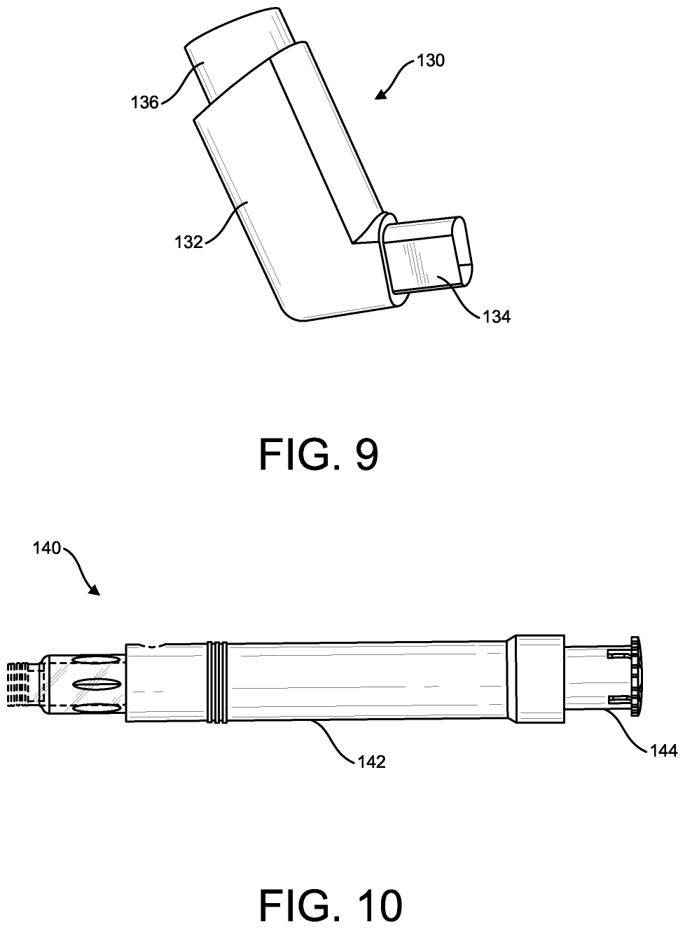

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

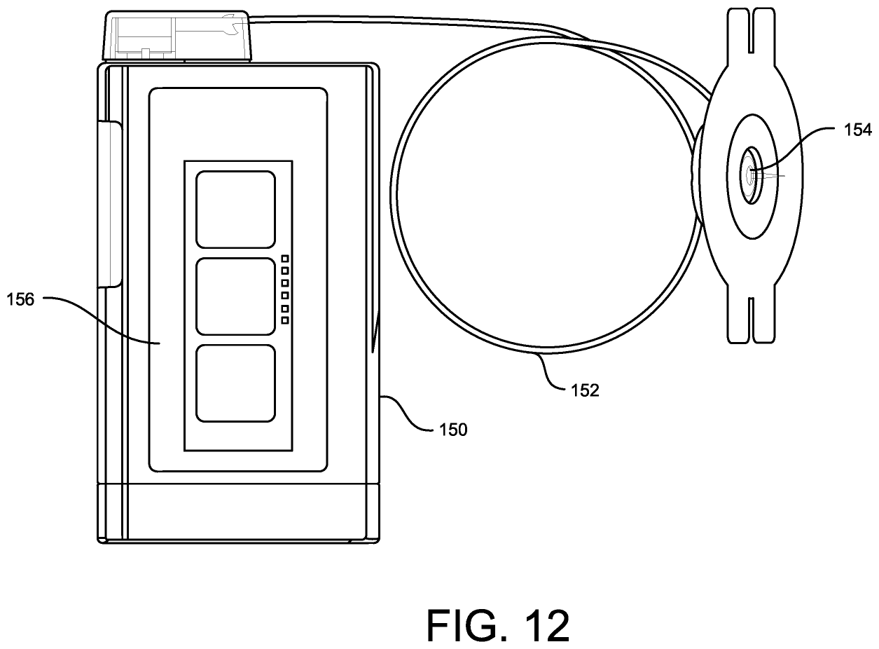

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

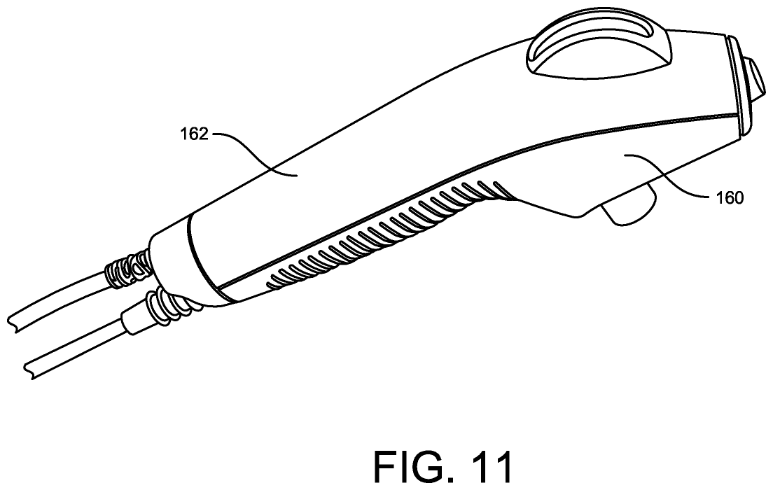

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the present disclosure so further described in such appended claims.

The present invention may be better understood with reference to the following examples.

### Test Methods

Crystallization Peak Temperature: The crystallization peak temperature may be determined by differential scanning calorimetry (“DSC”) as is known in the art. The crystallization peak temperature is the differential scanning calorimetry (DSC) peak crystallization temperature as determined by ISO 11357-3:2018. Under the DSC procedure, samples were heated and cooled at 20° C. per minute as stated in ISO 11357-3:2018 using DSC measurements conducted on a TA Q2000 Instrument.

Melting Peak Temperature: The melting peak temperature may be determined by differential scanning calorimetry (“DSC”) as is known in the art. The melting peak temperature is the differential scanning calorimetry (DSC) peak melting temperature as determined by ISO 11357-3:2018. Under the DSC procedure, samples were heated and cooled at 20° C. per minute as stated in ISO Standard 11357-3: 2018 using DSC measurements conducted on a TA Q2000 Instrument.

Enthalpy of Crystallization: The enthalpy of crystallization may be determined by differential scanning calorimetry (“DSC”) as is known in the art. The enthalpy of crystallization is the differential scanning calorimetry (DSC) enthalpy of crystallization as determined by ISO 11357-3:2018. Under the DSC procedure, samples were heated and cooled at 10° C. per minute as stated in ISO Standard 11357-3:2018 using DSC measurements conducted on a TA Q2000 Instrument.

Enthalpy of Fusion: The enthalpy of fusion may be determined by differential scanning calorimetry (“DSC”) as is known in the art. The enthalpy of fusion is the differential scanning calorimetry (DSC) enthalpy of fusion as determined by ISO 11357-3:2018. Under the DSC procedure, samples were heated and cooled at 20° C. per minute as stated in ISO Standard 11357-3:2018 using DSC measurements conducted on a TA Q2000 Instrument.

### EXAMPLES 1-15

Examples 1-5 are formed from various combinations of cellulose ester polymer, plasticizers, polycarboxylic acids, and antioxidants. The component values located in the table are representative of the percentage of the polymer composition comprised by the component.

TABLE 1

| | 1 | 2 | 3 | 4 | 5 |
|---|---|---|---|---|---|
| Cellulose Acetate | 71.885 | 71.885 | 71.885 | 71.885 | 71.885 |
| Diphosphite | 0.095 | 0.095 | 0.095 | 0.095 | 0.095 |
| Antioxidant | | | | | |
| Citric Acid | 0.02 | 0.02 | 0.02 | 0.02 | 0.02 |
| PEG 300 g/mol | 23 | 20 | 16 | 12 | 8 |
| PEG 1450 g/mol | 5 | 8 | 12 | 16 | 20 |
| PEG 1450% in PZ | 17.86 | 28.57 | 42.86 | 57.14 | 71.43 |

Examples 1-5 were tested for thermal and mechanical properties. The results are set forth below in Table 2.

TABLE 2

| | 1 | 2 | 3 | 4 | 5 |
|---|---|---|---|---|---|
| Observations | Clear | Clear | Translucent | Opaque | Opaque |
| | Pellets | Pellets | Pellets | Pellets | Pellets |
| Tc (° C.) | 151.6 | 160.4 | 168.5 | 178.6 | 187.5 |
| ΔHc (J/g) | 2.28 | 3.63 | 3.84 | 4.28 | 4.57 |
| Tm (° C.) | 178.5; | 185.6; | 190.5; | 196.8; | 203.9; |
| | 220.9 | 227.8 | 43.7 | 43.8 | 44.2 |
| ΔHm (J/g) | 3.03; | 3.19; | 3.32; | 4.18; | 5.08; |
| | 2.60 | 1.57 | 7.42 | 16.42 | 22.5 |
| Xc % CA | 6.2% | 11.3% | 7.9% | 9.9% | 12.0% |

Examples 6-10 are formed from various combinations of cellulose ester polymer, plasticizers, polycarboxylic acids, and antioxidants. The component values located in the table are representative of the percentage of the polymer composition comprised by the component.

TABLE 3

| | 6 | 7 | 8 | 9 | 10 |
|---|---|---|---|---|---|
| Cellulose Acetate | 71.885 | 71.885 | 71.885 | 71.885 | 71.885 |
| Diphosphite | 0.095 | 0.095 | 0.095 | 0.095 | 0.095 |
| Antioxidant | | | | | |
| Citric Acid | 0.02 | 0.02 | 0.02 | 0.02 | 0.02 |
| PEG 300 g/mol | 23 | 20 | 16 | 12 | 8 |
| PEG 3400 g/mol | 5 | 8 | 12 | 16 | 20 |
| PEG 3400% in PZ | 17.86 | 28.57 | 42.86 | 57.14 | 71.43 |

Examples 6-10 were tested for thermal and mechanical properties. The results are set forth below in Table 4.

TABLE 4

| | 6 | 7 | 8 | 9 | 10 |
|---|---|---|---|---|---|
| Observations | Translucent | Opaque | Opaque | Opaque | Opaque |
| | Pellets | Pellets | Pellets | Pellets | Pellets |
| Tc (° C.) | −23.58; | −22.78; | −16.6; | 14.6; | −14.7; |
| | 169.8 | 155.46 | 18.3 | 6.4; | 10.26; |
| | | | | 180.5 | 189.3 |
| ΔHc (J/g) | 3.84; | 5.71; | 9.64; | 12.0; | 11.9; |
| | 6.99 | 11.24 | 3.6 | 5.8; | 4.2; |
| | | | | 3.41 | 4.10 |
| Tm (° C.) | 51.3 | 51.94 | 52.9 | 53.5; | 53.6; |
| | | | | 201.4 | 208.9 |
| ΔHm (J/g) | 6.43 | 12.35 | 20.1 | 23.5; | 27.1; |
| | | | | 4.14 | 4.67 |
| Xc % CA | 0 | 0 | 0 | 9.8% | 11.0% |

Examples 11-15 are formed from various combinations of cellulose ester polymer, plasticizers, polycarboxylic acids, and antioxidants. The component values located in the table are representative of the percentage of the polymer composition comprised by the component.

TABLE 5

| | 11 | 12 | 13 | 14 | 15 |
|---|---|---|---|---|---|
| Cellulose Acetate | 71.885 | 71.885 | 71.885 | 71.885 | 71.885 |
| Diphosphite | 0.095 | 0.095 | 0.095 | 0.095 | 0.095 |
| Antioxidant | | | | | |
| Citric Acid | 0.02 | 0.02 | 0.02 | 0.02 | 0.02 |
| PEG 300 g/mol | 27 | 26 | 24 | 22 | 20 |
| PEG 10,000 g/mol | 1 | 2 | 4 | 6 | 8 |
| PEG 10,000% in PZ | 3.57 | 7.14 | 14.29 | 21.43 | 28.57 |

Examples 11-15 were tested for thermal and mechanical properties. The results are set forth below in Table 6.

TABLE 6

| | 11 | 12 | 13 | 14 | 15 |
|---|---|---|---|---|---|
| Observations | Clear | Clear | Translucent | Opaque | Opaque |
| | Pellets | Pellets | Pellets | Pellets | Pellets |
| Tc (° C.) | 150.5 | 147.8 | 166.7 | 165.9 | 157.8 |
| ΔHc (J/g) | 1.27 | 1.2 | 3.3 | 3.2 | 2.2 |
| Tm (° C.) | 54.9 | 49.1 | 52.4 | 55.5 | 48.8 |
| ΔHm (J/g) | 2.2 | 3.0 | 4.2 | 10.7 | 10.42 |
| Xc % CA | 0 | 0 | 0 | 0 | 0 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a cellulose ester polymer combined with at least one plasticizer;
wherein the at least one plasticizer comprises polyethylene glycol having a number average molecular weight from about 100 g/mol to about 800 g/mol and is present in the polymer composition in an amount from about 2% to about 50% by weight.

2. The polymer composition as defined in claim 1, wherein the polymer composition further comprises a second plasticizer.

3. The polymer composition as defined in claim 1, wherein the polymer composition exhibits a degree of crystallinity from about 2% to about 40%.

4. The polymer composition as defined in claim 1, wherein the polymer composition exhibits a haze from about 1% to about 20%.

5. The polymer composition as defined in claim 2, wherein the second plasticizer comprises polyethylene glycol having a number average molecular weight from about 1000 g/mol to about 15000 g/mol.

6. The polymer composition as defined in claim 2, wherein the second plasticizer is present in the polymer composition in an amount from about 3% to about 30% by weight.

7. The polymer composition as defined in claim 1, wherein the polymer composition further comprises glycerol triacetate, triethyl citrate, acetyl triethyl citrate, or mixtures thereof.

8. The polymer composition as defined in claim 1, wherein the cellulose ester polymer is present in the polymer composition in an amount from about 50% to about 95% by weight, and the at least one plasticizer is present in the polymer composition in an amount from about 5% to about 50% by weight.

9. The polymer composition as defined in claim 1, wherein the polymer composition displays at least one crystallization peak temperature is from about 150° C. to about 220° C. as determined by differential scanning calorimetry.

10. The polymer composition as defined in claim 1, wherein the polymer composition displays an enthalpy of crystallization of from about 1 J/g to about 7 J/g as determined by differential scanning calorimetry.

11. The polymer composition as defined in claim 1, wherein the polymer composition displays an enthalpy of fusion of from about 2 J/g to about 8 J/g as determined by differential scanning calorimetry.

12. The polymer composition as defined in claim 1, wherein the cellulose ester polymer consists essentially of cellulose diacetate.

13. The polymer composition as defined in claim 1, wherein the polymer composition further comprises an antioxidant.

14. The polymer composition as defined in claim 13, wherein the antioxidant is a phosphite.

15. The polymer composition as defined in claim 1, wherein the polymer composition further comprises a polycarboxylic acid.

16. The polymer composition as defined in claim 15, wherein the polycarboxylic acid is citric acid.

17. A molded polymer article formed from the polymer composition of claim 1.

18. The polymer article of claim 17, wherein the article is a beverage holder, a drinking straw, a hot beverage pod, a fork, a knife, a spoon, packaging, a container, a lid, an interior automotive part, or a consumer appliance part.

19. The polymer article of claim 17, wherein the article is a medical device.
